(19) United States
(12) Patent Application Publication
(10) Pub. No.: US 2002/0020505 A1
(43) Pub. Date: Feb. 21, 2002

(54) Device for heat sealing

(76) Inventors: Martin Hohnhorst, Ibbenbueren (DE); Stefan Esslage, Hoerstel (DE); Juergen Steinberg, Hoerstel (DE); Ruediger Duwendag, Lengerich (DE)

Correspondence Address: JACOBSON HOLMAN, 400 SEVENTH STREET, N.W., WASHINGTON, DC, 20004, US

(21) Appl. No.: 09/907,454

(22) Filed: Jul. 18, 2001

(30) Foreign Application Priority Data
Jul. 18, 2000 (DE) 100 34 910.2

(51) Int. Cl. B30B 5/02

(52) U.S. Cl. 156/583.2

(57) ABSTRACT

A device for the strip-shaped heat sealing or welding of the inner walls composed of a thermoplastic material and lying on top of one another of tube sections that are lying flat is comprised of two heated, longitudinally extending heating jaws, which limit a gap between one another, of means for pressing the tube sections together in one region of the heating jaws, and of a conveyor device that moves the tube sections through the gap. In order to prevent the tube sections from becoming offset relative to their conveyor devices, these means comprise a pair of rolls mounted in the region of the heating jaws, whose rolls form a pressing throughput nip for each tube section.

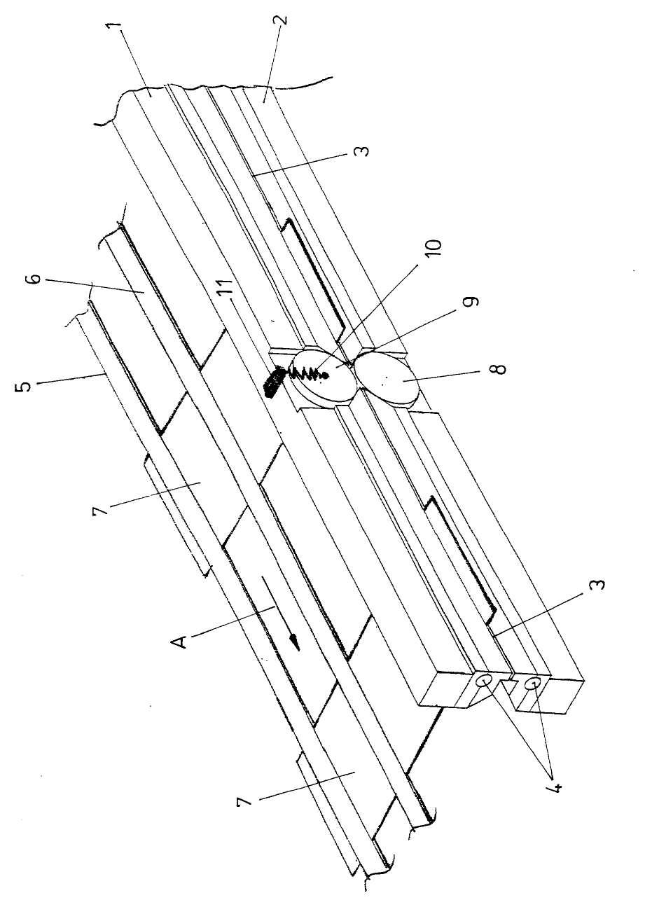

The invention relates to a device for the strip-shaped heat sealing or welding of the inner walls composed of a thermoplastic material and lying on top of one another of tube sections lying flat and continuously following one another, preferably tube sections made of paper with an inner layer of plastic material, comprising two longitudinal heating jaws that limit a gap between one another, means for pressing the tube sections together in one region of the heating jaws, and a conveyor device that moves the tube sections through the gap.

Heat sealing devices of this type are used, for example, in the production of so-called pinch bottom sacks. Pinch bottom sacks are comprised of tube sections, usually made of paper, whose inner walls are provided with a layer capable of being heat sealed. In order to form a tight base, tube sections lying flat are provided with a strip-shaped heat seal near and parallel to the cut edge on the side of the base by means of which the side walls of the tube section are welded to one another. Subsequently, the edge strips of the tube section on the side of the base are folded to one side wall and are bonded to it in order to increase the stability of the base structure. For the purpose of forming the traverse heat sealed seam sealing the base, the tube sections supplied in the traverse direction pass through the gap formed between the two heating jaws on its inlet side, with the gap conventionally being expanded in the shape of a wedge on its inlet side. In a known device, the pressing together of the strip-shaped regions of the tube sections heated by the heating jaws occurs in that the gap formed by the heating jaws narrows in the exit region. However, this narrowing leads to the fact that the tube sections travel over the sides of the heating jaws facing one another with increased friction such that the tube sections supplied by the conveyor device, which commonly comprises pairs of conveyor belts firmly clamping the tube sections between one another, are warped relative to the conveyor device and take on an offset position that complicates or even prevents a proper further processing.

The object of the invention is therefore to create a device of the type mentioned at the outset with which strip-shaped heat sealing seams can be applied to the tube sections supplied such that they follow one another without the concern arising that the tube sections will become offset relative to these supplying devices.

This object is attained according to the invention in that, in the region of the heating jaws, a pair of rolls is mounted whose rolls form a pressing throughput nip for each tube section.

In the device according to the invention, the heated heating jaws can have such a large distance from one another that the regions of the tube sections to be provided with the strip-shaped heat seal seams can be conveyed through the gap formed between these jaws in a friction-free or nearly friction-free manner. However, in order to produce a good heat sealing seam after a sufficient heating of the inner thermoplastic layer, rolls forming a clamping or pressing roll pair are provided according to the invention through which the regions of the tube sections to be provided with the heat sealing seams pass and thus are firmly pressed together such that the plasticized thermoplastic layers are welded to one another.

The rolls pressing together the tube sections passing through them in the region of the strip-shaped heat sealing seam to be formed can be mounted in a freely rotational fashion.

It is useful for each roll of the roll pair to be mounted on one of the two heating jaws. This leads to the rolls acquiring the temperature of the heating jaws and not removing any heat from the regions to be provided with heat sealing seams.

Naturally, it is also possible for at least one roll of the clamping roll pair with to be provided with a drive that drives this roll with a circumferential speed corresponding to the supply speed of the tube sections. By means of such a drive, forces acting on the tube sections and holding them back are further prevented.

In order to supply sufficient heat to the regions of the tube sections to be provided with heat sealing seams, it is useful to use several pairs of heating jaws with pressing roll pairs one behind the other in the supply direction, each of which is directed at the same seam to be formed.

An exemplary embodiment of the invention will be explained in greater detail in the following with reference to the drawing, in which the single figure shows the heat sealing device according to the invention schematically in perspective.

The device comprises at least one pair of heating jaws 1, 2 mounted on a machine frame, which is not shown, whose strip-shaped surfaces arranged opposite one another and transmitting and/or reflecting the heat, whose width determines the width of the seal seam to be formed, have a distance from one another forming a gap 3. In the longitudinally extending heating jaws 1, 2, electrically heatable heating rods 4 are arranged in the usual fashion. In the machine frame, which is not shown, several continuous, circulating double belts 5, 6 are arranged running parallel to one another, which travel over driving and deflection rolls, which are not shown, and which clamp the tube sections 7 to be provided with the strip-shaped interior heat sealing seams between their upper and lower sides and move as the conveyor device through the gap 3 between the heating jaws 1, 2 in the manner shown. The supply direction of the conveyor device comprising the continuous double belt pairs 5, 6 is in the direction of the arrow A.

In the end region of the heating jaws 1, 2, rolls 8, 9 are mounted in a freely rotational fashion on bearing pins that are not shown, which rolls form a clamping or pressing roll pair in the manner shown. The lower roll 8 is mounted on an bearing pin that is connected to the lower heating jaw 2 in a fixed manner such that the lower roll 8 is mounted in a rotational fashion without the bearing pin holding it being movable in the radial direction.

The upper roll 9 is mounted on a bearing pin that is movable in the vertical direction. A pressure spring 10, which is supported on a counter bearing that is connected to the upper heating jaw 1 in a fixed manner, acts on the bearing pin holding the roll 9 and attempts to press the upper roll 9 against the lower roll 8 of the clamping roll pair with a predetermined force.

In order to achieve a sufficient heating of the regions of the tube section 7 to be provided with the strip-shaped traverse heat sealing seam, multiple pairs, for example, four devices, of heating jaws of the type shown in the drawings are arranged in a manner not shown. For the purpose of transporting the tube sections through several devices, a single conveyor device comprising double belt conveyors 5, 6 can be provided.

1. Device for the strip-shaped heat sealing or welding of the inner walls composed of a thermoplastic material and lying on top of one another of tube sections (7) lying flat and continuously following one another, preferably tube sections (7) made of paper with an inner layer of plastic material, comprised
of two heated longitudinally extending heating jaws (1, 2) that limit a gap between one another,
of means for pressing the tube sections (7) together in one region of the heating jaws (1, 2), and
of a conveyor device that moves the tube sections (7) through the gap, characterized in that,
in the region of the heating jaws (1, 2), a pair of rolls is mounted whose rolls (8, 9) form a pressing throughput nip for each tube section (7).

2. Device in accordance with claim 1, characterized in that the rolls (8, 9) are mounted in a freely rotational fashion.

3. Device in accordance with claim 1 or 2, characterized in that each roll (8, 9) of the roll pair is mounted on one of the two heating jaws (1, 2).

4. Device in accordance with one of claims 1 to 3, characterized in that at least one roll (8, 9) of the roll pair is provided with a drive that drives it with a circumferential speed that corresponds to the supply speed of the tube sections (7).

5. Device in accordance with one of claims 1 to 4, characterized in that several heated heating jaws with pressing roll pairs are arranged in the supply direction of the tube sections and are directed at the same seam of the tube sections (7) to be formed.
